(19) United States
(12) Patent Application Publication
(10) Pub. No.: US 2024/0346259 A1
(43) Pub. Date: Oct. 17, 2024

(54) TRANSLATION PROCESSING METHOD, METHOD FOR TRAINING POST-EDITING MODEL, AND RELATED APPARATUSES

(71) Applicant: Tencent Technology (Shenzhen) Company Limited, Shenzhen (CN)

(72) Inventors: Zhen YANG, Shenzhen (CN); Fandong MENG, Shenzhen (CN)

(73) Assignee: Tencent Technology (Shenzhen) Company Limited, Shenzhen, GD (CN)

(21) Appl. No.: 18/746,939

(22) Filed: Jun. 18, 2024

Related U.S. Application Data
(63) Continuation of application No. PCT/CN2023/101610, filed on Jun. 21, 2023.

(30) Foreign Application Priority Data
Aug. 29, 2022 (CN) 202211041422.4

(51) Int. Cl. G06F 40/58

(52) U.S. Cl. CPC G06F 40/58

(57) ABSTRACT

Translation processing and training a post-editing model are performed. An input sequence including a plurality of segments and segment identifiers is obtained, where the plurality of segments includes a source language segment and a target language segment with a mask label, and the segment identifiers are configured to segment the source language segment and the target language segment. The mask label is located at a to-be-suggested position of the target language segment. An input vector of the input sequence is obtained by using a post-editing model based on a word vector, a position vector, and a segment vector corresponding to the input sequence. Encoding is performed by using the post-editing model based on the input vector to output an encoding result, and decoding is performed by using the post-editing model based on the encoding result to output a translation processing result corresponding to the to-be-suggested position.

### RELATED APPLICATION

This application is a continuation of International Patent Application No. PCT/CN2023/101610, filed Jun. 21, 2023, which claims priority to Chinese Patent Application No. 202211041422.4, entitled “TRANSLATION SUGGESTION METHOD, METHOD FOR TRAINING POST-EDITING MODEL, AND RELATED APPARATUSES”, filed with China National Intellectual Property Administration on Aug. 29, 2022. The contents of International Patent Application No. PCT/CN2023/101610 and Chinese Patent Application No. 202211041422.4 are each incorporated herein by reference in their entirety.

### FIELD OF THE TECHNOLOGY

This application relates to the field of machine translation, and in particular, to a translation processing technology.

### BACKGROUND OF THE DISCLOSURE

With the deepening of international communication, people's demand for language translation is increasing day by day. However, there is a large variety of languages in the world, each featured and formally flexible, making automatic processing of languages, including machine translation between languages, a crucial technology.

Machine translation, also known as automatic translation, is a process of converting a language (source language) into another language (target language) by using a computer, and generally refers to translation of sentences and full text between natural languages. Correspondingly, translated text obtained by machine translation refers to text in a language that is obtained by translating text in another language by a computer. Post-editing (Post-Editing, PS) refers to a process of refining a translation generated by machine translation, so that the translation is more in line with a human language style to obtain a better translation effect.

During post-editing, an inappropriate or incorrect part of the translation may need to be corrected. However, current post-editing modes have low accuracy and a poor effect.

### SUMMARY

To solve the above technical problems, this application provides a translation processing method, a method for training a post-editing model, and related apparatuses, which can explicitly distinguish a source language segment from a target language segment, and thus perform distinguishing modeling for different segments, thereby taking cross-language information into account when a translation processing result is output. This, in turn, may improve suggestion performance of a post-editing model and accuracy of the translation processing result, and thus improve accuracy of post-editing and a post-editing effect.

Embodiments of this application disclose the following technical solutions:

In an aspect, an embodiment of this application provides a translation processing method, performed by a computer device, and including:

obtaining an input sequence including a plurality of segments and segment identifiers, the plurality of segments including a source language segment and a target language segment with a mask label, the segment identifiers being configured to segment the source language segment and the target language segment, the target language segment being a first original translation of the source language segment, and the mask label being located at a to-be-suggested position of the target language segment;
performing embedding on the input sequence by using a post-editing model to obtain a word vector and a position vector corresponding to the input sequence, and performing embedding based on the segment identifiers to obtain a segment vector;
performing vector fusion by using the post-editing model based on the word vector, the position vector, and the segment vector corresponding to the input sequence to obtain an input vector of the input sequence;
performing encoding by using the post-editing model based on the input vector to output an encoding result; and
performing decoding by using the post-editing model based on the encoding result to output a translation processing result corresponding to the to-be-suggested position.

In another aspect, an embodiment of this application provides a method for training a post-editing model, performed by a computer device, and including:
obtaining an input sample sequence, the input sample sequence including a plurality of sample segments and sample segment identifiers, the plurality of sample segments including a source language sample segment and a target language sample segment with a mask label, the sample segment identifiers being configured to segment the source language sample segment and the target language sample segment, the target language sample segment being a first original sample translation of the source language sample segment, and the mask label being located at a suggested sample position of the target language sample segment;
performing embedding on the input sample sequence by using an initial network model to obtain a word vector and a position vector corresponding to the input sample sequence, and performing embedding based on the sample segment identifiers to obtain a segment vector;
performing vector fusion by using the initial network model based on the word vector, the position vector, and the segment vector corresponding to the input sample sequence to obtain an input sample vector of the input sample sequence;
performing encoding by using the initial network model based on the input sample vector to output a sample encoding result;
performing decoding by using the initial network model based on the sample encoding result to output a predicted translation processing result corresponding to the suggested sample position; and
training the initial network model based on the predicted translation processing result and a standard translation corresponding to the suggested sample position, to obtain the post-editing model.

In still another aspect, an embodiment of this application provides a translation processing apparatus, deployed on a computer device, and including an acquisition unit, a processing unit, a determining unit, an encoding unit, and a decoding unit,
the acquisition unit being configured to obtain an input sequence including a plurality of segments and segment identifiers, the plurality of segments including a source language segment and a target language segment with a mask label, the segment identifiers being configured to segment the source language segment and the target language segment, the target language segment being a first original translation of the source language segment, and the mask label being located at a to-be-suggested position of the target language segment;
the processing unit being configured to perform embedding on the input sequence by using a post-editing model to obtain a word vector and a position vector corresponding to the input sequence, and perform embedding based on the segment identifiers to obtain a segment vector;
the determining unit being configured to perform vector fusion by using the post-editing model based on the word vector, the position vector, and the segment vector corresponding to the input sequence to obtain an input vector of the input sequence;
the encoding unit being configured to perform encoding by using the post-editing model based on the input vector to output an encoding result; and
the decoding unit being configured to perform decoding by using the post-editing model based on the encoding result to output a translation processing result corresponding to the to-be-suggested position.

In yet another aspect, an embodiment of this application provides an apparatus for training a post-editing model, deployed on a computer device, and including an acquisition unit, a processing unit, a determining unit, an encoding unit, a decoding unit, and a training unit,
the acquisition unit being configured to obtain an input sample sequence, the input sample sequence including a plurality of sample segments and sample segment identifiers, the plurality of sample segments including a source language sample segment and a target language sample segment with a mask label, the sample segment identifiers being configured to segment the source language sample segment and the target language sample segment, the target language sample segment being a first original sample translation of the source language sample segment, and the mask label being located at a suggested sample position of the target language sample segment;
the processing unit being configured to: perform embedding on the input sample sequence by using an initial network model to obtain a word vector and a position vector corresponding to the input sample sequence, and perform embedding based on the sample segment identifiers to obtain a segment vector;
the determining unit being configured to perform vector fusion by using the initial network model based on the word vector, the position vector, and the segment vector corresponding to the input sample sequence to obtain an input sample vector of the input sample sequence;
the encoding unit being configured to perform encoding by using the initial network model based on the input sample vector to output a sample encoding result;
the decoding unit being configured to perform decoding by using the initial network model based on the sample encoding result to output a predicted translation processing result corresponding to the suggested sample position; and
the training unit being configured to train the initial network model based on the predicted translation processing result and a standard translation corresponding to the suggested sample position, to obtain the post-editing model.

In still yet another aspect, an embodiment of this application provides computer device, the computer device including a processor and a memory,
the memory being configured to store a computer program and transmit the computer program to the processor; and
the processor being configured to perform the method according to any one of the foregoing aspects based on instructions in the computer program.

In a further embodiment, an embodiment of this application provides a computer-readable storage medium, the computer-readable storage medium being configured to store a computer program, and the computer program, when executed by a processor, causing the processor to perform the method according to any one of the foregoing aspects.

In a still further aspect, an embodiment of this application provides a computer program product, including a computer program, the computer program, when executed by a processor, implementing the method according to any one of the foregoing aspects.

It can be seen from the above technical solutions that according to this application, during translation processing, an input sequence including a plurality of segments and segment identifiers may be obtained, where the plurality of segments include a source language segment and a target language segment with a mask label, and the segment identifiers are configured to segment the source language segment and the target language segment, so that the source language segment and the target language segment can be explicitly distinguished. The target language segment is a first original translation of the source language segment, and the mask label is located at a to-be-suggested position of the target language segment. The input sequence is input into a post-editing model. The input sequence is embedded by using the post-editing model to obtain a word vector and a position vector corresponding to the input sequence, embedding is performed based on the segment identifiers to obtain a segment vector, and thus vector fusion is performed by using the post-editing model based on the word vector, the position vector, and the segment vector corresponding to the input sequence to obtain an input vector of the input sequence. Because the input vector is obtained based on the word vector, the position vector, and the segment vector corresponding to the input sequence, and the segment vector is determined based on the segment identifiers, the input vector can explicitly distinguish the source language segment from the target language segment. In this way, when encoding is performed by using the post-editing model based on the input vector to output an encoding result, distinguishing modeling can be performed for different segments, to obtain the encoding result reflecting different segments, thereby taking cross-language information into account, and preventing, when decoding is performed by using the post-editing model based on the encoding result to output a translation processing result corresponding to the to-be-suggested position, the source language segment and the target language segment from being confused, which otherwise results in an inaccurate output translation processing result. It can be seen that in this solution, automatic translation processing can be performed by using the post-editing model for a user to choose, thus achieving post-editing. During translation processing, the source language segment can be explicitly distinguished from the target language segment, and thus distinguishing modeling is performed for different segments, thereby taking cross-language information into account when the translation processing result is output, improving suggestion performance of the post-editing model and accuracy of the translation processing result, and thus improving accuracy of post-editing and a post-editing effect.

### BRIEF DESCRIPTION OF THE DRAWINGS

To more clearly describe the technical solutions in the embodiments of this application or in the related art, the accompanying drawings required for describing the embodiments or the related art will be briefly described below. Apparently, the accompanying drawings in the following description merely show some of the embodiments of the present application, and those of ordinary skill in the art may still derive other accompanying drawings according to these accompanying drawings without creative efforts.

FIG. 1 is an architecture diagram of an application scenario of a translation processing method according to an embodiment of this application.

FIG. 2 is a flowchart of a translation processing method according to an embodiment of this application.

FIG. 3 is a structural diagram of a post-editing model according to an embodiment of this application.

FIG. 4 is a flowchart of a method for training a post-editing model according to an embodiment of this application.

FIG. 5 illustrates a structure of a translation processing apparatus according to an embodiment of this application.

FIG. 6 is a structural diagram of an apparatus for training a post-editing model according to an embodiment of this application.

FIG. 7 is a structural diagram of a terminal according to an embodiment of this application.

FIG. 8 is a structural diagram of a server according to an embodiment of this application.

### DESCRIPTION OF EMBODIMENTS

Embodiments of this application are described below with reference to the accompanying drawings.

During post-editing, an inappropriate translation in translated text needs to be corrected, and a translation used to correct the inappropriate translation may be selected by a user based on a suggested translation. In this case, to achieve post-editing, there is a need to suggest a translation to the user.

Current translation suggestion (TS) methods are mainly based on multilingual pretraining models such as a cross-lingual language model (XLM). The method may be to optimize the model by using a training objective of a masked language model (MLM), so that the model predicts words at positions that have been masked.

However, the method directly splices a source language segment and a target language segment together, and then transmits the same to the model for modeling. This simple splicing input cannot provide segment information of the source language segment and the target language segment to the model, so that the model cannot perform distinguishing modeling based on different segments, which leads to limited performance, thereby leading to low accuracy and a poor effect of post-editing.

To solve the above technical problems, an embodiment of this application provides a translation processing method. In the method, an input sequence including a plurality of segments and segment identifiers is input into a post-editing model, and a source language segment and a target language segment are segmented by segment identifiers, so that the source language segment can be explicitly distinguished from the target language segment. In this way, distinguishing modeling can be performed for different segments by using the post-editing model, thereby taking cross-language information into account when a translation processing result is output, improving suggestion performance of the post-editing model and accuracy of the translation processing result, and thus improving accuracy of post-editing and a post-editing effect.

The method according to the embodiment of this application can be applied to any translation scenario that needs post-editing, which may be, for example, a machine translation scenario and a manual translation scenario. The embodiment of this application is described mainly with a machine translation scenario as an example.

The translation processing method according to the embodiment of this application can be performed by a computer device, which may be, for example, a server or a terminal. Specifically, the method may be performed by the server or the terminal alone, or by the server and the terminal in cooperation. The server may be, for example, an independent server or a server in a cluster. The terminal includes, but is not limited to, a smartphone, a computer, an intelligent voice interaction device, a smart home appliance, an on-board terminal, and an aircraft.

The method according to the embodiment of this application can be applied to various scenarios such as cloud technology, artificial intelligence, intelligent transportation, and assisted driving.

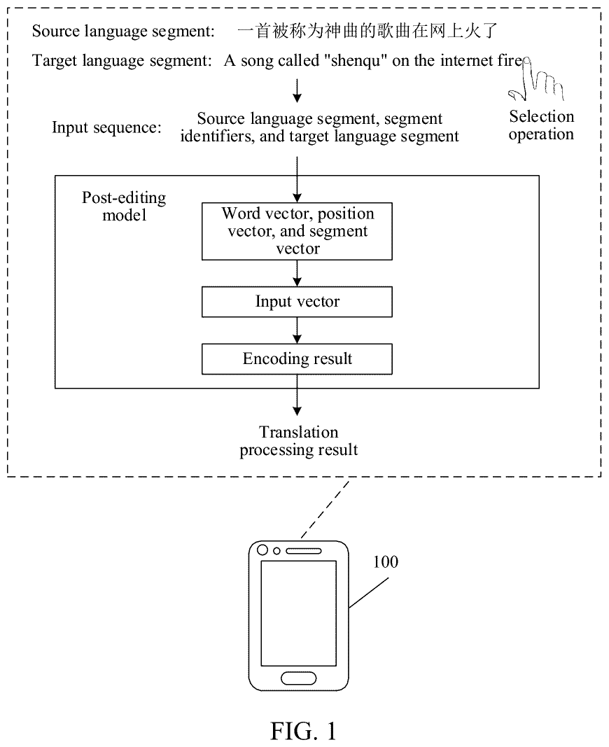

FIG. 1 is an architecture diagram of an application scenario of a translation processing method. The application scenario is described with an example in which a terminal performs the translation processing method according to the embodiment of this application. In this application scenario, a terminal 100 may be included. When a language (source language) needs to be converted into another language (target language), the terminal 100 may use machine translation to translate a source language segment to obtain a target language segment. To improve translation quality, post-editing may be performed on the target language segment generated by machine translation, so as to improve a translation, so that the translation is more in line with a human language style to obtain a better translation effect.

During post-editing, the user may perform a selection operation on the terminal 100, to select part of the translation to be corrected, so as to trigger the translation processing method according to the embodiment of this application. There may be multiple modes of triggering the translation processing method. For example, the translation processing method may be triggered directly based on a selection operation, or may be triggered by clicking a “Translation” control after the user performs the selection operation.

Then, the terminal 100 may obtain an input sequence including a plurality of segments and segment identifiers, where the plurality of segments include a source language segment and a target language segment with a mask label, and the segment identifiers are configured to segment the source language segment and the target language segment, so that the source language segment and the target language segment can be explicitly distinguished. The target language segment is a first original translation of the source language segment. The mask label is located at a to-be-suggested position of the target language segment, and the translation at the to-be-suggested position is masked by the mask label.

The source language segment may be language text that needs to be translated into a target language. A source language may be various known languages, such as Chinese, English, German, and French, and the target language may be a language different from the source language. The target language segment may be a translation (i.e., a first original translation) obtained by translating the source language segment. For example, the source language segment is “ [symbol] [symbol] ”, and if the target language is English, the target language segment may be “A song called “shenqu” on the internet fire”.

The to-be-suggested position may be a position of part of the translation to be corrected in the target language segment, and translation candidates need to be suggested for this position. The to-be-suggested position may be determined based on the user's selection operation. For example, the Word “ [symbol] ” in the above source language segment is wrongly translated into “fire” in the target language segment. During post-editing, the user may perform a selection operation on the “fire”, to select the “fire” as part of the translation to be corrected. The position of the “fire” in the target language segment may be referred to as a to-be-suggested position.

The terminal 100 inputs the input sequence into a post-editing model, embeds the input sequence by using the post-editing model to obtain a word vector and a position vector corresponding to the input sequence, performs embedding based on the segment identifiers to obtain a segment vector, and thus performs vector fusion by using the post-editing model based on the word vector, the position vector, and the segment vector corresponding to the input sequence to obtain an input vector of the input sequence.

Because the input vector is obtained based on the word vector, the position vector, and the segment vector corresponding to the input sequence, and the segment vector is determined based on the segment identifiers, the input vector can explicitly distinguish the source language segment from the target language segment. In this way, the terminal 100 can perform, when encoding is performed by using the post-editing model based on the input vector to output an encoding result, distinguishing modeling for different segments, to obtain the encoding result reflecting different segments, thereby taking cross-language information into account, and preventing, when decoding is performed by using the post-editing model based on the encoding result to output a translation processing result corresponding to the to-be-suggested position, the source language segment and the target language segment from being confused, which otherwise results in an inaccurate output translation processing result. Therefore, suggestion performance of the post-editing model and accuracy of the translation processing result are improved, and thus accuracy of post-editing and a post-editing effect are improved.

The method according to the embodiment of this application mainly involves artificial intelligence, and automation of translation processing is achieved by using an artificial intelligence technology. The method according to the embodiment of this application mainly involves a natural language processing technology and machine learning/deep learning in the artificial intelligence technology. For example, operations such as outputting the translation processing result corresponding to the to-be-suggested position may involve a machine translation technology in the natural language processing technology, and the post-editing model provided in the embodiment of this application may be trained by machine learning.

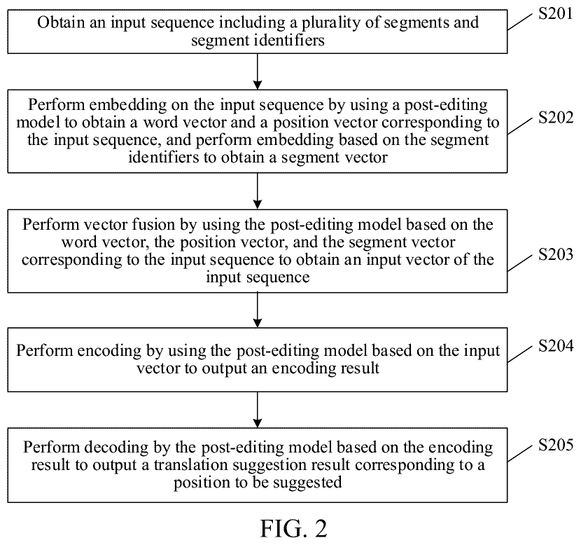

Next, with an example in which a terminal performs a translation processing method, the translation processing method according to the embodiment of this application is described in detail with reference to the accompanying drawings. FIG. 2 is a flowchart of a translation processing method. The method includes the following operations.

S201: Obtain an input sequence including a plurality of segments and segment identifiers.

When a language (source language) needs to be converted into another language (target language), the terminal may use machine translation to translate a source language segment to obtain a target language segment. To improve translation quality, post-editing may be performed on the target language segment generated by machine translation, so as to improve a translation (referred to as a first original translation herein), so that the translation is more in line with a human language style to obtain a better translation effect.

During post-editing, the user may perform a selection operation on the terminal, to select part of the translation to be corrected, so as to trigger the translation processing method according to the embodiment of this application. Part of the translation to be corrected may be, for example, a translation error, an unsmooth sentence, or a missing translation content.

For example, the source language is Chinese, and the target language is English. The source language segment is “ [symbol] [symbol] ”, and the target language segment is “A song called “shenqu” on the internet fire”. The “fire” in the target language segment is translated wrongly. During post-editing, the user may perform a selection operation on the “fire”, to select the “fire” as part of the translation to be corrected, so as to trigger performing of the translation processing method according to the embodiment of this application. The position of the “fire” in the target language segment may be referred to as a to-be-suggested position.

Then the terminal may obtain an input sequence including a plurality of segments and segment identifiers. The plurality of segments include a source language segment and a target language segment with a mask label, and the segment identifiers are configured to segment the source language segment and the target language segment. The target language segment is a first original translation of the source language segment, and the mask label is located at a to-be-suggested position of the target language segment.

The segment identifiers may be represented by symbols, numbers, etc., and usually, may be represented by a symbol <sep>. The to-be-suggested position may be a position of part of the translation to be corrected in the target language segment, and translation candidates need to be suggested for this position. The to-be-suggested position may be determined based on the user's selection operation.

When the source language segment is represented by x and the target language segment with a mask label is represented by m, the input sequence may be represented as:
[x; <sep>; m]
where [a; b] represents splicing of a and b, and represents splicing of x and m herein, and <sep> is a segment identifier, and is a symbol configured to segment the source language segment and the target language segment.

S202: Perform embedding on the input sequence by using a post-editing model to obtain a word vector and a position vector corresponding to the input sequence, and perform embedding based on the segment identifiers to obtain a segment vector.

After the input sequence is obtained, the input sequence may be embedded by using the post-editing model to obtain the word vector and the position vector corresponding to the input sequence, and embedding is performed based on the segment identifiers to obtain the segment vector.

In a possible implementation, when a word vector is determined, the input sequence may be segmented to obtain input words, and for each input word, look-up is performed in a word vector table (token embedding) to obtain a word vector of the word. In addition, to model a position of each word, a position vector can be introduced. For each segment, a position vector (position embedding) is calculated separately, that is, position vectors of the source language segment and the target language segment are obtained respectively, and thus the position vector of the whole input sequence is obtained. In addition, to distinguish between different segments, a segment vector (segment embedding) is further introduced. The segment vector functions to distinguish the source language segment from the target language segment. Therefore, the segment vector may be that identifiers corresponding to words belonging to a same segment may be the same, and identifiers corresponding to words belonging to different segments are different. For example, identifiers corresponding to words belonging to the source language segment are all 0, and identifiers corresponding to words belonging to the target language segment are all 1.

The structure of the post-editing model is not limited in the embodiment of this application. In a possible implementation, the post-editing model may be implemented based on an encoder-decoder transformer framework, and in this case, the post-editing model may include an input layer, an encoder, and a decoder. The encoder and the decoder are both neural networks. An output of the encoder is used as an encoding of the input sequence. The output of the encoder is used as an input of the decoder, and the output of the decoder is a desired result (i.e., a translation processing result). In the embodiment of this application, the target result can be the translation processing result. An input of the encoder is a variable-length vector (i.e., an input vector of the input sequence), and the output thereof is a fixed-length vector (i.e., a subsequent encoding result). The output of the decoder is a variable-length vector (i.e., the translation processing result).

Correspondingly, the implementation of S202 may be to obtain the word vector, the position vector, and the segment vector corresponding to the input sequence by the input layer.

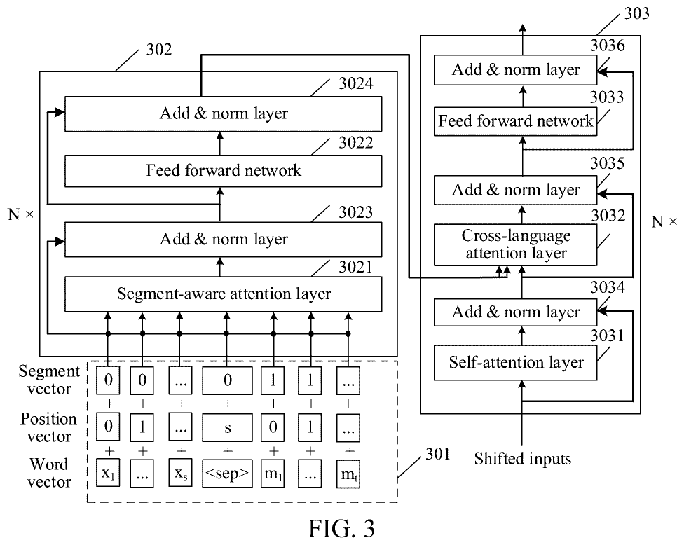

In this case, the structural diagram of the post-editing model may be shown in FIG. 3, including an input layer 301, an encoder 302, and a decoder 303. After the input sequence is input to the input layer 301, the word vector, the position vector, and the segment vector corresponding to the input sequence are obtained at the input layer 301. For the mode in which the input layer obtains the word vector, the position vector, and the segment vector corresponding to the input sequence, reference may be made to the aforementioned description. That is, at the input layer, the input sequence is segmented to obtain input words, and for each input word, look-up is performed in the word vector table to obtain a word vector of the word. In addition, for each segment, encoding is performed based on a position of each word in the segment to obtain a position vector of the word. For all words, it is determined whether the words belong to a same segment. Identifiers corresponding to words belonging to a same segment may be the same, and identifiers corresponding to words belonging to different segments are different, for example, identifiers corresponding to words belonging to the source language segment are all 0, and identifiers corresponding to words belonging to the target language segment are all 1, thereby obtaining the segment vector. With an example in which the above source language segment is represented by x, the target language segment with a mask label is represented by m, and the segment identifiers are represented by <sep>, if x includes s words, m includes t words (one of which may be mask), and <sep> is used as one word, word vectors corresponding to the input sequence may be x1, . . . , xs, <sep>, m1, . . . , mt in sequence (see FIG. 3); position vectors may be 0, 1, . . . , s, 0, 1, . . . in sequence (see FIG. 3); and segment vectors may be 0, 0, . . . , 0, 1, 1, . . . in sequence (see FIG. 3).

S203: Perform vector fusion by using the post-editing model based on the word vector, the position vector, and the segment vector corresponding to the input sequence to obtain an input vector of the input sequence.

After the word vector, the position vector, and the segment vector corresponding to the input sequence are obtained, the terminal may perform vector fusion by using the post-editing model to obtain the input vector of the input sequence. The vector fusion is to merge a plurality of vectors into a more comprehensive vector, so that one vector can represent semantics of a word itself, a position of the word in a segment, and a segment to which the word belongs. There may be multiple modes of vector fusion. For example, the word vector, the position vector, and the segment vector of each word may be directly spliced to obtain a final input vector; or the word vector, the position vector, and the segment vector corresponding to each word may be summed, so as to obtain a final input vector. Herein, a mode of summing the word vector, the position vector, and the segment vector may be weighted summation, and weights of the word vector, the position vector, and the segment vector may be the same or different, which is not limited in the embodiment of this application, but may be determined based on an influence degree of each type of vector on the translation processing result.

If the post-editing model includes an input layer, an encoder, and a decoder, as shown in FIG. 3, the implementation of S203 may be to obtain the input vector of the input sequence by the input layer based on the word vector, the position vector, and the segment vector corresponding to the input sequence. That is, the above-mentioned splicing or summation processing may be performed at the input layer to obtain the input vector.

With the above-mentioned word vectors, position vectors, and segment vectors in as an example in FIG. 3, the word vector, the position vector, and the segment vector of each word are in a one-to-one correspondence (i.e., in a vertical queue in FIG. 3), and the word vector, the position vector, and the segment vector located in a vertical queue may be summed, so as to obtain a vector representation (which may be referred to as a feature vector) after fusion of the vector at the position of each word, and all feature vectors form the input vector of the input sequence.

S204: Perform encoding by using the post-editing model based on the input vector to output an encoding result.

After the input vector of the input sequence is obtained, the terminal may encode the input vector by using the post-editing model to output the encoding result. In fact, the encoding herein is to perform feature extract on the input vector to obtain the encoding result that can reflect features of the input vector.

Because the input vector is obtained based on the word vector, the position vector, and the segment vector corresponding to the input sequence, and the segment vector is determined based on the segment identifiers, the input vector can explicitly distinguish the source language segment from the target language segment. In this way, the terminal can perform, when encoding is performed by using the post-editing model based on the input vector to output an encoding result, distinguishing modeling for different segments. That is, segment-aware may be implemented to obtain the encoding result reflecting different segments, thereby taking cross-language information into account, and preventing, when decoding is performed by using the post-editing model based on the encoding result to output a translation processing result corresponding to the to-be-suggested position, the source language segment and the target language segment from being confused, which otherwise results in an inaccurate output translation processing result, thereby improving accuracy of the translation processing result.

If the post-editing model includes an input layer, an encoder, and a decoder, as shown in the FIG. 3, the implementation of S204 may be to transmit the input vector to the encoder 302, so as to perform encoding by the encoder 302 based on the input vector to output the encoding result. During translation processing, the translation processing result corresponding to the to-be-suggested position of the target language segment needs to be predicted based on the input sequence, and a specific translation processing result corresponding to the to-be-suggested position may be related to other words in the input sequence. Some words may have a strong relationship, while others may have a weak or even no relationship. To improve accuracy of the translation processing result obtained by subsequent decoding, words in the input sequence that are more critical to the predicted translation processing result need to be accurately selected. Therefore, an attention mechanism may be introduced. The attention mechanism is similar to a human selective visual attention mechanism in essence, with a core objective being also to select information that is more critical to a current task objective (decoding to obtain the translation processing result) from a large amount of information (such as all words in the input sequence).

In this case, the input vector of the input sequence is composed of feature vectors of all words after vector fusion. A mode of performing encoding by the encoder based on the input vector to output the encoding result may be to process by the encoder by means of the attention mechanism based on the input vector to obtain an attention weight of each feature vector, that is, to perform attention mechanism calculation on each feature vector by the encoder, to obtain the attention weight of each feature vector. Then, the input vector is encoded by the encoder based on the attention weight to output the encoding result, so that more information is reserved for feature vectors with greater attention weights in the encoding result. In this way, the influence degree of each feature vector on the predicted translation processing result can be determined, so as to subsequently predict the translation processing result in combination with the influence degree of the word vector and improve accuracy of the translation processing result obtained by subsequent decoding.

The attention mechanism may be implemented by an attention layer. Because the input vector is calculated based on the segment vector in the embodiment of this application, and segment-aware can be achieved based on the segment vector, the attention mechanism may be referred to as a segment-aware attention mechanism, and the attention layer may be referred to as a segment-aware attention layer. In this case, the encoder may include a segment-aware attention layer. If the whole encoder is formed by stacking N identical modules, each module includes one segment-aware attention layer and one simple feed forward network (FFN), and of course, may further include other layers, such as an add & norm layer.

As shown in FIG. 3, the encoder 302 includes N modules, and one module includes a segment-aware attention layer 3021, a feed forward network 3022, and two add & norm layers. The two add & norm layers are shown as 3023 and 3024, respectively. The segment-aware attention layer 3021 is configured to calculate an attention weight. A function of the feed forward network 3022 is spatial transformation. Usually, the FFN includes two linear transformation layers, and an in-between activation function is ReLu. Behind each module in a main framework, there is an add & norm layer, which is a general technology, which essentially can effectively improve the vanishing gradient problem in a deep model, break network symmetry, improve against the network degradation problem, accelerate convergence, and standardize an optimization space. For example, the segment-aware attention layer 3021 is followed by the add & norm layer 3023, and the feed forward network 3022 is followed by the add & norm layer 3024.

The attention mechanism in the related art is configured to extract higher-order information of input information (such as the input vector of the input sequence), but does not explicitly distinguish between different segments in the input sequence. In this case, the attention weight is calculated in the following mode:

$$\frac{Q {W}^{Q} ( {KW}^{K} )}{\sqrt{{d}_{x}}} \qquad ( 1 )$$

where Q and K are a query word and a key word in the attention mechanism, respectively, and are specifically word vectors in the input vector; WQ and WK are mapping matrices, and are specifically parameters of the attention layer; and dx is a dimension of the input vector.

For the task of translation processing, the input sequence includes two types of segments from different sources, namely, the source language segment and the target language segment with a mask label. Different segments provide different information to the post-editing model, and thus distinguishing modeling is to be performed explicitly. However, the attention mechanism provided by the related art cannot distinguish between information of different segments in the input sequence. Based on these analyses, an embodiment of this application proposes a segment-aware attention mechanism, that is, when an attention weight is calculated, a segment vector is introduced for calculation. In this case, based on the input vector, the attention weight of each word segment in a plurality of segments that is obtained through processing by the encoder by using the attention mechanism may be calculated in the following mode:

$$\frac{( {E}_{seg} \cdot Q ) {W}^{Q} ( ( {E}_{seg} \cdot K ) {W}^{K} )}{\sqrt{{d}_{x}}} \qquad ( 2 )$$

Eseg is a segment vector, the segment vector can share parameters with the segment vector in the input layer, and a·b represents point multiplication of a and b.

The embodiment of this application proposes the segment-aware attention mechanism, so that different segments in the input sequence can be explicitly distinguished during modeling, thereby improving an ability of the post-editing model.

There may be multiple attention mechanisms, such as a self-attention mechanism, a cross-language attention mechanism, and a multi-head attention mechanism. The embodiment of this application mainly describes self-attention mechanism and the cross-language attention mechanism.

When the attention mechanism is the self-attention mechanism, the segment-aware attention layer 3021 in FIG. 3 may be a segment-aware self-attention layer. In this case, a mode of obtaining the attention weight of each feature vector through processing by the encoder by using the attention mechanism based on the input vector may be to perform, for each feature vector, attention calculation on the feature vector and other feature vectors belonging to the same segment as the feature vector. Specifically, with each feature vector in the input vector used as a first feature vector, attention calculation may be performed on the first feature vector and each third feature vector based on the segment vector in the input vector, to obtain an attention weight of the first feature vector. The third feature vector and the first feature vector belong to a same segment. Herein, performing attention calculation on the first feature vector and each third feature vector based on the segment vector in the input vector essentially means that feature vectors belonging to the same segment as the first feature vector can be determined based on identifiers of the segment vector, so that the feature vectors are used as the third feature vectors, and thus attention calculation is performed on the first feature vector and each third feature vector to obtain the attention weight of the first feature vector.

If the calculation formula of the attention weight is shown in the above formula (2), K and Q in the formula (2) belong to a same segment. For example, K represents the first feature vector and belongs to the source language segment, and Q represents the third feature vector and also belongs to the source language segment.

By the self-attention mechanism, a degree of correlation between each feature vector and other feature vectors in the same segment can be determined, and thus an influence degree of the feature vector on the generated translation processing result can be determined. Influences of feature vectors on each other are fully considered, which helps to improve accuracy of the translation processing result obtained by subsequent decoding.

When the attention mechanism is the cross-language attention mechanism, the segment-aware attention layer 3021 in FIG. 3 may be a segment-aware cross-language attention layer. In this case, a mode of obtaining the attention weight of each feature vector through processing by the encoder by using the attention mechanism based on the input vector may be to perform, for each feature vector, attention calculation on the feature vector and other feature vectors belonging to a segment different from the segment to which the feature vector belongs. Specifically, with each feature vector in the input vector used as a first feature vector, attention calculation may be performed on the first feature vector and each second feature vector based on the segment vector in the input vector, to obtain an attention weight of the first feature vector. The second feature vector and the first feature vector belong to different segments. Herein, performing attention calculation on the first feature vector and each second feature vector based on the segment vector in the input vector essentially means that feature vectors belonging to a segment different from the segment to which the first feature vector belongs can be determined based on identifiers of the segment vector, so that the feature vectors are used as the second feature vectors, and thus attention calculation is performed on the first feature vector and each second feature vector to obtain the attention weight of the first feature vector.

If the calculation formula of the attention weight is shown in the above formula (2), K and Q in the formula (2) belong to different segments. For example, K represents the first feature vector and belongs to the source language segment, and Q represents the second feature vector and belongs to the target language segment.

By the cross-language attention mechanism, a correlation between different segments is considered, so that when the translation processing result is obtained by subsequent decoding, word information in the source language segment may be combined to provide more abundant information for obtaining the translation processing result by decoding, thereby improving accuracy of the translation processing result.

S205: Perform decoding by using the post-editing model based on the encoding result to output a translation processing result corresponding to the to-be-suggested position.

After obtaining the encoding result, the terminal continues to decode the encoding result by using the post-editing model to output the translation processing result corresponding to the to-be-suggested position.

If the post-editing model includes an input layer, an encoder, and a decoder, as shown in the FIG. 3, the implementation of S205 may be to output, by the encoder, the encoding result and transmit the encoding result to the decoder, and thus perform decoding by the decoder based on the encoding result to output the translation processing result corresponding to the to-be-suggested position, that is, to decode the encoding result by the decoder, and output the translation processing result corresponding to the to-be-suggested position. In this case, due to the characteristics of the decoder, the translation processing result may include a plurality of translation candidates of different text lengths.

With an example in which the above-mentioned source language segment is “ [symbol] [symbol] [symbol] ”, and the target language segment is “A song called “shenqu” on the internet fire”, translation candidates corresponding to the to-be-suggested position may be “became popular”, “has become popular”, and “has been popular”.

The translation processing results is provided to the user, so that the user can select a translation candidate therein as the translation at the to-be-suggested position, and complete post-editing of the target language segment.

In the translation processing method provided in the related art by using MLM, because a fixed number of mask labels are placed during each decoding, and each mask label can predict only one word, this method can generate only a translation of a single length during each decoding, thereby greatly reducing a diversity of translations in the translation processing result. In addition, the number of mask labels is manually defined. Therefore, a level of manual intervention in such a model is excessively high, thereby greatly reducing a degree of freedom of the model, and greatly compromising prediction performance of the model. In addition, because only a translation of a single length can be obtained by decoding each time, to provide the user with translation candidates of different lengths, this method requires decoding for many times, resulting in a huge decoding time and low efficiency.

The encoder-decoder transformer framework is introduced in the embodiment of this application, to formalize translation processing into a text generation task. In this method, translations of different lengths can be generated by the decoder only by placing a mask label at the to-be-suggested position, so that translation candidates of different lengths can be generated in one decoding, which greatly improves the diversity of translations in the translation processing result and decoding efficiency.

In the embodiment of this application, the decoder may also be formed by stacking N identical modules, and each module includes a self-attention layer, a cross-language attention layer, and a feed forward network, and of course, may further include other layers, such as an add & norm layer.

Referring to FIG. 3, the decoder 303 includes a self-attention layer 3031, a cross-language attention layer 3032, a feed forward network 3033, and three add & norm layers 3034, 3035, and 3036. The self-attention layer 3031 is followed by the add & norm layer 3034, the cross-language attention layer 3032 is followed by the add & norm layer 3035, and the feed forward network 3033 is followed by the add & norm layer 3036.

The self-attention layer 3031 is configured to encode input information, and the cross-language attention layer 3032 is configured to pay attention to information of the source language segment encoded by the encoder. For functions of the feed forward network 3033 and the three add & norm layers, reference may be made to the encoder, and details are not described herein.

During decoding, the input of the decoder is an output result (shifted inputs) obtained by decoding at the last moment, as shown in FIG. 3. Beam search is performed in the output result of the decoder to obtain a final translation processing result. For example, an original translation corresponding to the to-be-suggested position is “ [symbol] ”. When the decoder performs decoding, an output result of “ [symbol] ” may be first obtained by decoding; then this output result is used as an input at the next moment, and decoding continues to obtain an output result of “ [symbol] ”; the output result of “ [symbol] ” is used as an input at the next moment, decoding continues to obtain “ [symbol] ”, and a finally obtained translation processing result is “ [symbol] [symbol] ”.

The method according to the embodiment of this application was tested on public data sets WMT19EN-Zh and WMT14En-De. Experimental results are shown in Table 1. It can be seen that this method has achieved the best translation effects in four translation directions: English-Chinese (En→Zh), Chinese-English (Zh→En), English-German (En→De), and German-English (De→En).

TABLE 1

| | | BLEU | | | | BLEURT | | | |
|---|---|---|---|---|---|---|---|---|---|
| No. | Method | Zh→En | En→Zh | De→En | En→De | Zh→En | En→Zh | De→En | En→De |
| 1 | Related | 21.25 | 32.48 | 27.40 | 25.12 | 40.17 | 52.05 | 37.21 | 36.40 |
| | technology | | | | | | | | |
| | 1 | | | | | | | | |
| 2 | Related | 24.20 | 35.01 | 30.08 | 28.15 | 43.32 | 54.60 | 41.05 | 41.21 |
| | technology | | | | | | | | |
| | 2 | | | | | | | | |
| 3 | Related | 24.29 | 35.10 | 30.23 | 28.09 | 43.12 | 54.75 | 42.01 | 50.95 |
| | technology | | | | | | | | |
| | 3 | | | | | | | | |
| 4 | This method | 25.51 | 36.28 | 31.20 | 29.48 | 44.67 | 56.48 | 42.66 | 42.13 |

Table 1 provides four translation processing methods, namely a related technology 1 (for example, an XLM-based translation processing method), a related technology 2 (for example, a translation processing method based on a native transformer), a related technology 3 (for example, a translation processing method based on a dual-source transformer), and this method. BLEU and BLEURT are two evaluation indexes to measure translation processing effects. As can be seen from Table 1, compared with the three related technologies, this method has relatively large values of BLEU and BLEURT in the above four translation directions, that is, this method has a better post-editing effect than the related technologies. In the Chinese-English translation direction, this method increased the BLEU value by 1.3. The experimental results fully demonstrate effectiveness of this method.

Table 2 shows several examples in which translation processing is performed based on the method according to the embodiment of this application, as follows:

TABLE 2

| | | Translation processing |
|---|---|---|
| No. | Input sequence | result |
| 1 | [symbol] | 1 became popular |
| (Zh→ | A song called “shenqu” on the internet | 2 has become popular |
| En) | fire | 3 has been popular |
| 2 | [symbol] , [symbol] ? | 1 do you want to |
| (Zh→ | Today is beautiful day, want to go out | 2 do you like to |
| En) | shopping together? | 3 you want to |
| 3 | A new measure has been taken to | 1 [symbol] |
| (En→ | achieve effective class unity | 2 [symbol] |
| Zh) | [symbol] , | 3 [symbol] |
| | [symbol] | |
| | [symbol] | |
| 4 | . . . | |
| (En→ | | |
| Zh) | | |

In the first example, Chinese is translated into English (i.e., Zh→En), and a source language segment in an input sequence is “ [symbol] [symbol] ”, while a target language segment is “A song called “shenqu” on the internet fire”, and “ [symbol] ” in the source language segment is wrongly translated into “fire”. When the user chooses a position of the “fire” as a to-be-suggested position, this method can provide correct translation processing results, namely “became popular”, “has become popular”, and “has been popular”.

The second example, which is also Zh→En, shows that this method can suggest a missing part in a target language segment. A source language segment in an input sequence is “ [symbol] [symbol] , [symbol] ?”, while a target language segment is “Today is beautiful day, want to go out shopping together?”, “want to” in the target language segment is missing, and thus this method can provide correct translation processing results, which are “do you want to”, “do you like to”, and “you want to”.

The third example, in which English is translated into Chinese (i.e., En→Zh), shows that this method can suggest a smoother translation. A source language segment in an input sequence is “A new measure have been taken to achieve effective class unity”, while a target language segment is “ [symbol] , [symbol] ”, and “ [symbol] ” [symbol] in the target language segment is not smooth enough, and thus this method can provide correct translation processing results, which are “ [symbol] ”, “ [symbol] [symbol] ”, and “ [symbol] ”.

It can be seen from the above technical solutions that according to this application, during translation processing, an input sequence including a plurality of segments and segment identifiers may be obtained, where the plurality of segments include a source language segment and a target language segment with a mask label, and the segment identifiers are configured to segment the source language segment and the target language segment, so that the source language segment and the target language segment can be explicitly distinguished. The target language segment is a first original translation of the source language segment, and the mask label is located at a to-be-suggested position of the target language segment. The input sequence is input into a post-editing model. The input sequence is embedded by using the post-editing model to obtain a word vector and a position vector corresponding to the input sequence. In addition, embedding is performed based on the segment identifiers to obtain a segment vector, and thus vector fusion is performed by using the post-editing model based on the word vector, the position vector, and the segment vector corresponding to the input sequence to obtain an input vector of the input sequence. Because the input vector is obtained based on the word vector, the position vector, and the segment vector corresponding to the input sequence, and the segment vector is determined based on the segment identifiers, the input vector can explicitly distinguish the source language segment from the target language segment. In this way, when encoding is performed by using the post-editing model based on the input vector to output an encoding result, distinguishing modeling can be performed for different segments, to obtain the encoding result reflecting different segments, thereby taking cross-language information into account, and preventing, when decoding is performed by using the post-editing model based on the encoding result to output a translation processing result corresponding to the to-be-suggested position, the source language segment and the target language segment from being confused, which otherwise results in an inaccurate output translation processing result. It can be seen that in this solution, automatic translation processing can be performed by using the post-editing model for the user to choose, thus achieving post-editing. During translation processing, the source language segment can be explicitly distinguished from the target language segment, and thus distinguishing modeling is performed for different segments, thereby taking cross-language information into account when the translation processing result is output, improving suggestion performance of the post-editing model and accuracy of the translation processing result, and thus improving accuracy of post-editing and a post-editing effect.

During translation processing, the source language segment and the target language segment are segmented to obtain corresponding words, including a mask label, segment identifiers, etc. In addition, word alignment information between the source language segment and the target language segment can provide a richer basis for decoding to obtain the translation processing result at the to-be-suggested position, which facilitates finding of corresponding words during decoding in translation processing. Therefore, in the embodiment of this application, the source language segment and the target language segment may alternatively be aligned based on the input vector to obtain word alignment information between the source language segment and the target language segment. Thus, when decoding is performed by using the post-editing model based on the encoding result to output the translation processing result corresponding to the to-be-suggested position, decoding may be performed by using the post-editing model based on the word alignment information and the encoding result, to output the translation processing result.

According to the embodiment of this application, effective word alignment information can be mined, and thus decoding is performed by using the word alignment information, which may improve performance of translation processing based on the word alignment information contained in the input sequence.

Because the to-be-suggested position is masked by the mask label, when the word alignment information is determined, an original translation (i.e., a second original translation) corresponding to the mask label may be predicted first, and then the word alignment information may be determined. That is, the source language segment and the target language segment are aligned based on the input vector. A mode of obtaining the word alignment information between the source language segment and the target language segment may be to predict the second original translation at the to-be-suggested position by using the post-editing model based on the input vector, that is, to predict the input vector by using the post-editing model to obtain the second original translation at the to-be-suggested position. Thus, the mask label may be replaced with the second original translation to obtain a target language segment after the replacement, and align the source language segment with the target language segment after the replacement to obtain the word alignment information.

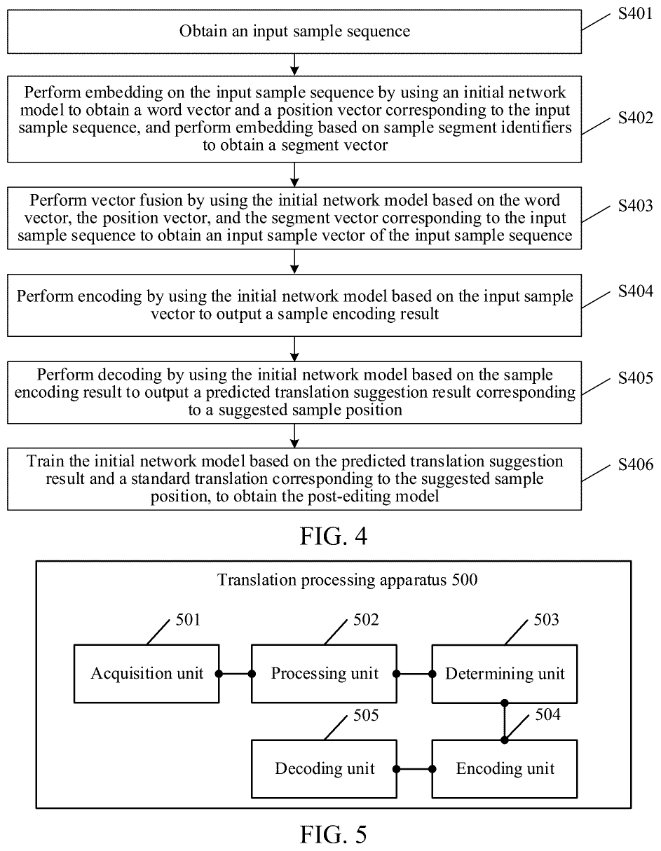

In the aforementioned embodiment, the post-editing model is used to automatically achieve translation processing, and thus post-editing is completed. Performance of the post-editing model has a great influence on accuracy of the translation processing result and is a key to translation processing. To this end, an embodiment of this application further provides a method for training a post-editing model. As shown in FIG. 4, the method includes the following operations.

S401: Obtain an input sample sequence.

The input sample sequence includes a plurality of sample segments and sample segment identifiers, and the plurality of sample segments include a source language sample segment and a target language sample segment with a mask label. The sample segment identifiers are configured to segment the source language sample segment and the target language sample segment, and the target language sample segment is a first original sample translation of the source language sample segment. The mask label is located at a suggested sample position of the target language sample segment.

S402: Perform embedding on the input sample sequence by using an initial network model to obtain a word vector and a position vector corresponding to the input sample sequence, and perform embedding based on the sample segment identifiers to obtain a segment vector.

S403: Perform vector fusion by using the initial network model based on the word vector, the position vector, and the segment vector corresponding to the input sample sequence to obtain an input sample vector of the input sample sequence.

S404: Perform encoding by using the initial network model based on the input sample vector to output a sample encoding result.

In S404, the input sample vector is encoded by using the initial network model to obtain the sample encoding result. A specific encoding mode may be shown in S204.

S405: Perform decoding by using the initial network model based on the sample encoding result to output a predicted translation processing result corresponding to the suggested sample position.

In S405, the sample encoding result is decoded by using the initial network model to output the predicted translation processing result corresponding to the suggested sample position. A specific decoding mode may be shown in S205.

S406: Train the initial network model based on the predicted translation processing result and a standard translation corresponding to the suggested sample position, to obtain the post-editing model.

In S406, a mode of training the initial network model may be to compare a difference between the predicted translation processing result and the standard translation, so as to adjust model parameters of the initial network model based on the difference until the difference between the predicted translation processing result and the standard translation is minimized, and determine a current corresponding adjusted initial network model as the post-editing model.

In the embodiment of this application, the input sample sequence including the plurality of segments and the segment identifiers is input into the initial network model, and the source language sample segment and the target language sample segment are segmented by the segment identifiers, so that the source language sample segment can be explicitly distinguished from the target language sample segment. In this way, distinguishing modeling can be performed for different segments by using the initial network model, thereby taking cross-language information into account when the predicted translation processing result is output, improving accuracy of the predicted translation processing result during training and suggestion performance of the post-editing model obtained through training, and thus improving accuracy of post-editing and a post-editing effect.

During training of the post-editing model, the process of processing the input sample sequence is similar to the process of processing the input sequence in the corresponding embodiment of FIG. 2. For details, reference may be made to S201-S205, and details are not described herein. However, during training, after the predicted translation processing result is obtained, the model parameters of the initial network model need to be optimized by using the predicted translation processing result. Specifically, the model parameters of the initial network model may be optimized based on the predicted translation processing result and the standard translation corresponding to the suggested sample position, so as to train the initial network model to obtain the post-editing model.

To obtain a more accurate predicted translation processing result during training, in the embodiment of this application, the source language sample segment and the target language sample segment may alternatively be aligned based on the input sample vector to obtain sample word alignment information between the source language sample segment and the target language sample segment. In this way, when S405 is performed, decoding may be performed by using the initial network model based on the sample word alignment information and the sample encoding result, to output the predicted translation processing result corresponding to the suggested sample position.

In a possible implementation, a mode of determining the sample word alignment information may be to predict a second original sample translation at the suggested sample position by using the initial network model based on the input sample vector, that is, to predict the input sample vector by using the initial network model to obtain the second original sample translation, and thus replace the mask label at the suggested sample position in the target language sample segment with the second original sample translation to obtain a target language sample segment after the replacement. Then, the source language sample segment is aligned with the target language sample segment after the replacement to obtain the sample word alignment information.

If the post-editing model is shown in FIG. 3, the second original sample translation corresponding to the mask label may be predicted by the encoder 302, and thus the sample word alignment information is obtained. Then, the sample word alignment information and the sample encoding result are input to the decoder 303 for decoding.

That is, during training, to improve performance of the post-editing model obtained through training, in addition to obtaining the sample translation processing result, the second original sample translation further needs to be predicted. The two that are used are tasks that need to be learned during training. That is, a multi-task training mode is introduced in the embodiment of this application, so as to improve performance of the post-editing model and thus improve a translation processing effect.

In this case, the two tasks need to be trained. In a possible implementation, the two tasks may be trained alternately, so as to promote each other and improve training efficiency. In this case, the initial network model is trained based on the predicted translation processing result and the standard translation corresponding to the suggested sample position. A mode of obtaining the post-editing model may be to perform first training on the initial network model based on the second original sample translation and a labeled original sample translation at the suggested sample position, perform second training on the initial network model based on the predicted translation processing result and the standard translation corresponding to the suggested sample position, and alternately perform the first training and the second training until a training stop condition is met, to obtain the post-editing model.

The multi-task training mode is introduced in the embodiment of this application to perform iterative training of a word alignment task and a translation processing task, that is, to alternately train a batch translation processing task and a batch word alignment task, and effectively use information contained in the input sample sequence to improve a suggestion effect.

In the specific implementation of this application, user information and other relevant data may be involved during translation processing. When the above embodiments of this application are applied to specific products or technologies, the user's separate consent or separate permission needs to be obtained, and collection, use, and processing of relevant data need to comply with relevant laws, regulations, and standards of relevant countries and regions.

Based on the implementations provided in the above aspects of this application, the implementations may be further combined to provide more implementations.

Based on the translation processing method according to the corresponding embodiment of FIG. 2, an embodiment of this application further provides a translation processing apparatus 500. Referring to FIG. 5, the translation processing apparatus 500 includes an acquisition unit 501, a processing unit 502, a determining unit 503, an encoding unit 504, and a decoding unit 505, where:
the acquisition unit 501 is configured to obtain an input sequence including a plurality of segments and segment identifiers, where the plurality of segments include a source language segment and a target language segment with a mask label, the segment identifiers are configured to segment the source language segment and the target language segment, the target language segment is a first original translation of the source language segment, and the mask label is located at a to-be-suggested position of the target language segment;
the processing unit 502 is configured to perform embedding on the input sequence by using a post-editing model to obtain a word vector and a position vector corresponding to the input sequence, and perform embedding based on the segment identifiers to obtain a segment vector;
the determining unit 503 is configured to perform vector fusion by using the post-editing model based on the word vector, the position vector, and the segment vector corresponding to the input sequence to obtain an input vector of the input sequence;
the encoding unit 504 is configured to perform encoding by using the post-editing model based on the input vector to output an encoding result; and
the decoding unit 505 is configured to perform decoding by using the post-editing model based on the encoding result to output a translation processing result corresponding to the to-be-suggested position.

In a possible implementation, the post-editing model includes an input layer, an encoder, and a decoder, and the processing unit 502 is configured to:
obtain the word vector, the position vector, and the segment vector corresponding to the input sequence by the input layer;
the determining unit 503 is configured to:
obtain the input vector of the input sequence by the input layer based on the word vector, the position vector, and the segment vector corresponding to the input sequence;
the encoding unit 504 is configured to:
perform encoding by the encoder based on the input vector to output the encoding result; and
the decoding unit 505 is configured to:
perform decoding by the decoder based on the encoding result to output the translation processing result corresponding to the to-be-suggested position.

In a possible implementation, the translation processing result includes a plurality of translation candidates of different text lengths.

In a possible implementation, the input vector includes a plurality of feature vectors obtained after the vector fusion, and the encoding unit 504 is configured to:
perform processing by the encoder based on the input vector by using an attention mechanism to obtain an attention weight of each feature vector; and
encode the input vector by the encoder based on the attention weight to output the encoding result.

In a possible implementation, the attention mechanism is a cross-language attention mechanism, and the encoding unit 504 is configured to:
perform, with each feature vector in the input vector used as a first feature vector, attention calculation on the first feature vector and each second feature vector based on the segment vector in the input vector, to obtain an attention weight of the first feature vector, where the second feature vector and the first feature vector belong to different segments.

In a possible implementation, the attention mechanism is a self-attention mechanism, and the encoding unit 504 is configured to:
perform, with each feature vector in the input vector used as a first feature vector, attention calculation on the first feature vector and each third feature vector based on the segment vector in the input vector, to obtain an attention weight of the first feature vector, where the third feature vector and the first feature vector belong to a same segment.

In a possible implementation, the determining unit 503 is further configured to:
align the source language segment with the target language segment according to the input vector to obtain word alignment information between the source language segment and the target language segment; and
the decoding unit 505 is configured to:
perform decoding by using the post-editing model based on the word alignment information and the encoding result, to output the translation processing result.

In a possible implementation, the determining unit 503 is configured to:
predict a second original translation at the to-be-suggested position by using the post-editing model based on the input vector;
replace the mask label with the second original translation, to obtain a target language segment after the replacement; and
align the source language segment with the target language segment after the replacement to obtain the word alignment information.

It can be seen from the above technical solutions that according to this application, during translation processing, an input sequence including a plurality of segments and segment identifiers may be obtained, where the plurality of segments include a source language segment and a target language segment with a mask label, and the segment identifiers are configured to segment the source language segment and the target language segment, so that the source language segment and the target language segment can be explicitly distinguished. The target language segment is a first original translation of the source language segment, and the mask label is located at a to-be-suggested position of the target language segment. The input sequence is input into a post-editing model. The input sequence is embedded by using the post-editing model to obtain a word vector and a position vector corresponding to the input sequence, embedding is performed based on the segment identifiers to obtain a segment vector, and thus vector fusion is performed by using the post-editing model based on the word vector, the position vector, and the segment vector corresponding to the input sequence to obtain an input vector of the input sequence. Because the input vector is obtained based on the word vector, the position vector, and the segment vector corresponding to the input sequence, and the segment vector is determined based on the segment identifiers, the input vector can explicitly distinguish the source language segment from the target language segment. In this way, when encoding is performed by using the post-editing model based on the input vector to output an encoding result, distinguishing modeling can be performed for different segments, to obtain the encoding result reflecting different segments, thereby taking cross-language information into account, and preventing, when decoding is performed by using the post-editing model based on the encoding result to output a translation processing result corresponding to the to-be-suggested position, the source language segment and the target language segment from being confused, which otherwise results in an inaccurate output translation processing result. In this solution, automatic translation processing can be performed by using the post-editing model for the user to choose, thus achieving post-editing. During translation processing, the source language segment can be explicitly distinguished from the target language segment, and thus distinguishing modeling is performed for different segments, thereby taking cross-language information into account when the translation processing result is output, improving suggestion performance of the post-editing model and accuracy of the translation processing result, and thus improving accuracy of post-editing and a post-editing effect.

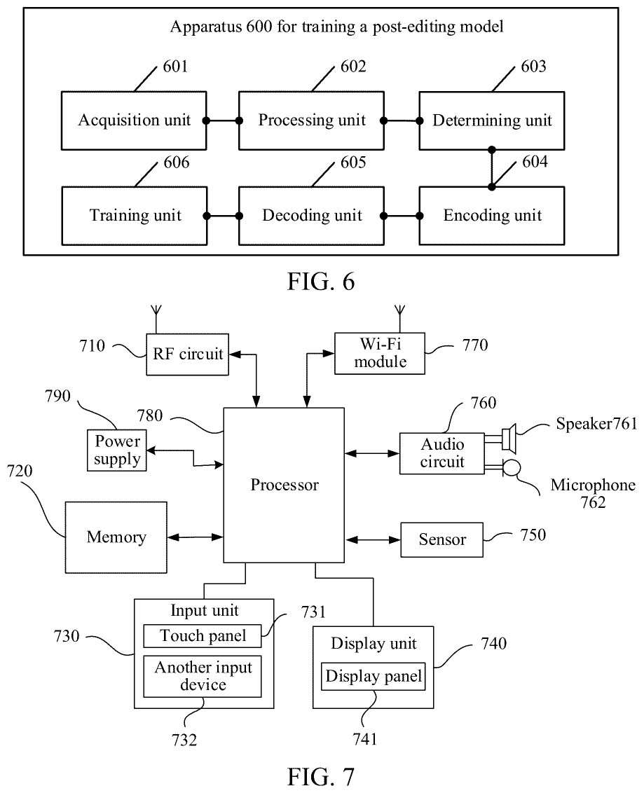

Based on the method for training a post-editing model according to the corresponding embodiment of FIG. 4, an embodiment of this application further provides an apparatus 600 for training a post-editing model. Referring to FIG. 6, the apparatus 600 for training a post-editing model includes an acquisition unit 601, a processing unit 602, a determining unit 603, an encoding unit 604, a decoding unit 605, and a training unit 606, where
the acquisition unit 601 is configured to obtain an input sample sequence, where the input sample sequence includes a plurality of sample segments and sample segment identifiers, the plurality of sample segments include a source language sample segment and a target language sample segment with a mask label, the sample segment identifiers are configured to segment the source language sample segment and the target language sample segment, the target language sample segment is a first original sample translation of the source language sample segment, and the mask label is located at a suggested sample position of the target language sample segment;
the processing unit 602 is configured to perform embedding on the input sample sequence by using an initial network model to obtain a word vector and a position vector corresponding to the input sample sequence, and perform embedding based on the sample segment identifiers to obtain a segment vector;
the determining unit 603 is configured to perform vector fusion by using the initial network model based on the word vector, the position vector, and the segment vector corresponding to the input sample sequence to obtain an input sample vector of the input sample sequence;
the encoding unit 604 is configured to perform encoding by using the initial network model based on the input sample vector to output a sample encoding result;
the decoding unit 605 is configured to perform decoding by using the initial network model based on the sample encoding result to output a predicted translation processing result corresponding to the suggested sample position; and
the training unit 606 is configured to train the initial network model based on the predicted translation processing result and a standard translation corresponding to the suggested sample position, to obtain the post-editing model.

In a possible implementation, the determining unit 603 is further configured to:
align the source language sample segment with the target language sample segment according to the input sample vector to obtain sample word alignment information between the source language sample segment and the target language sample segment; and the decoding unit 605 is configured to:
perform decoding by using the initial network model according to the sample word alignment information and the sample encoding result, to output the predicted translation processing result.

In a possible implementation, the determining unit 603 is configured to:
predict a second original sample translation at the suggested sample position by
using the initial network model based on the input sample vector;
replace the mask label with the second original sample translation, to obtain a target language sample segment after the replacement; and
align the source language sample segment with the target language sample segment after the replacement to obtain the sample word alignment information.

In a possible implementation, the training unit 606 is configured to:
perform first training on the initial network model based on the second original sample translation and a labeled original sample translation at the suggested sample position;
perform second training on the initial network model based on the predicted translation processing result and the standard translation; and
alternately perform the first training and the second training until a training stop condition is met, to obtain the post-editing model.

In the embodiment of this application, the input sample sequence including the plurality of segments and the segment identifiers is input into the initial network model, and the source language sample segment and the target language sample segment are segmented by the segment identifiers, so that the source language sample segment can be explicitly distinguished from the target language sample segment. In this way, distinguishing modeling can be performed for different segments by using the initial network model, thereby taking cross-language information into account when the predicted translation processing result is output, improving accuracy of the predicted translation processing result during training and suggestion performance of the post-editing model obtained through training, and thus improving accuracy of post-editing and a post-editing effect.

An embodiment of this application further provides a computer device, which can perform a translation processing method or a method for training a post-editing model. The computer device may be, for example, a terminal, with an example in which the terminal is a smartphone:

FIG. 7 is a block diagram of a partial structure of a smartphone according to an embodiment of this application. Referring to FIG. 7, the smartphone includes components such as a radio frequency (RF) circuit 710, a memory 720, an input unit 730, a display unit 740, a sensor 750, an audio circuit 760, a wireless fidelity (Wi-Fi) module 770, a processor 780, and a power supply 790. The input unit 730 may include a touch panel 731 and another input device 732. The display unit 740 may include a display panel 741. The audio circuit 760 may include a speaker 761 and a microphone 762. The structure of the smartphone shown in FIG. 7 does not constitute a limitation to the smartphone, and may include more or fewer components than those shown, or combine some components, or have different component arrangements.

The memory 720 may be configured to store software programs and modules, and the processor 780 executes various functional applications and data processing of the smartphone by running the software programs and the modules stored in the memory 720. The memory 720 may mainly include a program storage area and a data storage area. The program storage area may store an operating system, an application program (such as a sound playing function and an image playing function) required for at least one function, etc. The data storage area may store data (such as audio data, and a phone book) created based on use of the smartphone, etc. In addition, the memory 720 may include a high-speed random access memory, and may further include a non-volatile memory, such as at least one disk storage device, a flash memory device, or other volatile solid-state storage devices.

The processor 780 is a control center of the smartphone, connects all parts of the whole smartphone by using various interfaces and lines, and executes various functions and processing data of the smartphone by running or executing software programs and/or modules stored in the memory 720 and invoking data stored in the memory 720. In some embodiments, the processor 780 may include one or more processing units. Preferably, the processor 780 may integrate an application processor and a modem processor, where the application processor mainly handles an operating system, a user interface, application programs, etc., and the modem processor mainly handles wireless communication. The above modem processor may not be integrated into the processor 780.

In this embodiment, the processor 780 in the smartphone may perform the following operations:
obtaining an input sequence including a plurality of segments and segment identifiers, where the plurality of segments include a source language segment and a target language segment with a mask label, the segment identifiers are configured to segment the source language segment and the target language segment, the target language segment is a first original translation of the source language segment, and the mask label is located at a to-be-suggested position of the target language segment;
performing embedding on the input sequence by using a post-editing model to obtain a word vector and a position vector corresponding to the input sequence, and performing embedding based on the segment identifiers to obtain a segment vector;
performing vector fusion by using the post-editing model based on the word vector, the position vector, and the segment vector corresponding to the input sequence to obtain an input vector of the input sequence;
performing encoding by using the post-editing model based on the input vector to output an encoding result; and
performing decoding by using the post-editing model based on the encoding result to output a translation processing result corresponding to the to-be-suggested position; or
obtaining an input sample sequence, where the input sample sequence includes a plurality of sample segments and sample segment identifiers, the plurality of sample segments include a source language sample segment and a target language sample segment with a mask label, the sample segment identifiers are configured to segment the source language sample segment and the target language sample segment, the target language sample segment is a first original sample translation of the source language sample segment, and the mask label is located at a suggested sample position of the target language sample segment;
performing embedding on the input sample sequence by using an initial network model to obtain a word vector and a position vector corresponding to the input sample sequence, and performing embedding based on the sample segment identifiers to obtain a segment vector;
performing vector fusion by using the initial network model based on the word vector, the position vector, and the segment vector corresponding to the input sample sequence to obtain an input sample vector of the input sample sequence;
performing encoding by using the initial network model based on the input sample vector to output a sample encoding result;
performing decoding by using the initial network model based on the sample encoding result to output a predicted translation processing result corresponding to the suggested sample position; and
training the initial network model based on the predicted translation processing result and a standard translation corresponding to the suggested sample position, to obtain the post-editing model.

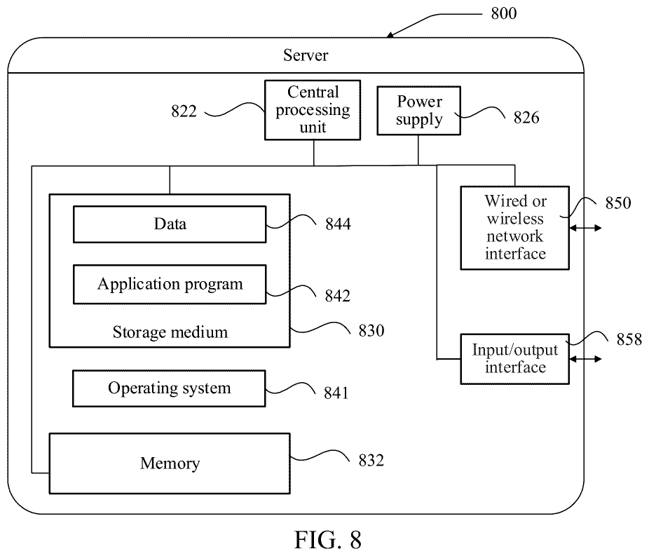

The computer device according to the embodiment of this application may alternatively be a server. FIG. 8 is a structural diagram of a server 800 according to an embodiment of this application. The server 800 may be quite different due to different configurations or performance, and may include one or more processors, such as a central processing unit (CPU) 822, a memory 832, and one or more storage media 830 (for example, one or more mass storage devices) for storing application programs 842 or data 844. The memory 832 and the storage medium 830 may be configured for transient storage or persistent storage. The program stored on the storage medium 830 may include one or more modules (not shown), and each module may include a series of instruction operations on the server. Further, the central processing unit 822 may be configured to communicate with the storage medium 830 and execute, on the server 800, a series of instruction operations in the storage medium 830.

The server 800 may further include one or more power supplies 826, one or more wired or wireless network interfaces 850, one or more input/output interfaces 858, and/or one or more operating systems 841, such as Windows Server™, Mac OS X™, Unix™, Linux™, and FreeBSD™.

In this embodiment, the central processing unit 822 in the server 800 may perform the following operations:
obtaining an input sequence including a plurality of segments and segment identifiers, where the plurality of segments include a source language segment and a target language segment with a mask label, the segment identifiers are configured to segment the source language segment and the target language segment, the target language segment is a first original translation of the source language segment, and the mask label is located at a to-be-suggested position of the target language segment;
performing embedding on the input sequence by using a post-editing model to obtain a word vector and a position vector corresponding to the input sequence, and performing embedding based on the segment identifiers to obtain a segment vector;
performing vector fusion by using the post-editing model based on the word vector, the position vector, and the segment vector corresponding to the input sequence to obtain an input vector of the input sequence;
performing encoding by using the post-editing model based on the input vector to output an encoding result; and
performing decoding by using the post-editing model based on the encoding result to output a translation processing result corresponding to the to-be-suggested position; or
obtaining an input sample sequence, where the input sample sequence includes a plurality of sample segments and sample segment identifiers, the plurality of sample segments include a source language sample segment and a target language sample segment with a mask label, the sample segment identifiers are configured to segment the source language sample segment and the target language sample segment, the target language sample segment is a first original sample translation of the source language sample segment, and the mask label is located at a suggested sample position of the target language sample segment;
performing embedding on the input sample sequence by using an initial network model to obtain a word vector and a position vector corresponding to the input sample sequence, and performing embedding based on the sample segment identifiers to obtain a segment vector;
performing vector fusion by using the initial network model based on the word vector, the position vector, and the segment vector corresponding to the input sample sequence to obtain an input sample vector of the input sample sequence;
performing encoding by using the initial network model based on the input sample vector to output a sample encoding result;
performing decoding by using the initial network model based on the sample encoding result to output a predicted translation processing result corresponding to the suggested sample position; and
training the initial network model based on the predicted translation processing result and a standard translation corresponding to the suggested sample position, to obtain the post-editing model.

According to an aspect of this application, a computer-readable storage medium is provided, where the computer-readable storage medium is configured to store a computer program, and the computer program is configured to perform the method according to each of the foregoing embodiments.

According to another aspect of this application, a computer program product is provided, where the computer program product includes a computer program, and the computer program product is stored in a computer-readable storage medium. A processor of a computer device reads the computer program from the computer-readable storage medium, and the processor executes the computer program, so that the computer device performs the method according to each of the various alternative implementations of the above embodiments.

The descriptions of the processes or structures corresponding to the above accompanying diagrams each have their own emphases. For parts that are not detailed in a process or structure, reference may be made to the relevant descriptions of other processes or structures.

The terms “first”, “second”, “third”, “fourth”, etc. (if any) in the specification of this application and the foregoing accompanying drawings are used to distinguish between similar objects and are not necessarily used to describe a specific order or sequence. Data used in such a way may be interchanged under appropriate circumstances such that the embodiments of this application described herein can, for example, be implemented in an order other than those illustrated or described herein. In addition, the terms “including” and “having”, and any variations thereof, are intended to cover non-exclusive inclusion, for example, a process, method, system, product, or device including a series of operations or units is not necessarily limited to those operations or units explicitly listed, but may include other operations or units not explicitly listed or inherent to these processes, methods, products, or devices.

In several embodiments of this application, the disclosed systems, apparatuses, and methods may be implemented in another mode. For example, the foregoing apparatus embodiments are only schematic, for example, the division of the units is only a logical function division, and there may be other modes of division in actual implementation. For example, a plurality of units or components may be combined or integrated into another system, or some features may be ignored or not be executed. In addition, the shown or discussed mutual coupling or direct coupling or communication connection may be indirect coupling or communication connection by using some interfaces, apparatuses, or units, which may be in electrical, mechanical, or another form.

The units described as separate components may or may not be physically separated, and the components displayed as units may be or may not be physical units, that is, the units or the components may be located in one place, or may be distributed in a plurality of network units. Some or all of the units may be selected based on actual requirements to achieve the objectives of the solutions of this embodiment.

In addition, the functional units in each embodiment of this application may be integrated in one processing unit, or each unit may exist physically alone, or two or more units may be integrated into one unit. The foregoing integrated unit may be implemented in a form of hardware, or may be implemented in a form of a software functional unit.

The integrated unit may be stored in a computer-readable storage medium if implemented in a form of a software functional unit and sold or used as an independent product. Based on such understanding, the technical solutions of this application essentially or the part contributing to the related art or the whole or part of the technical solution may be implemented in a form of a software product. The computer software product is stored in a storage medium, and includes several instructions for enabling a computer device (which may be a computer, a server, a network device, or the like) to perform all or some operations of the method according to each of the embodiments of this application. The foregoing storage medium includes various media that can store computer programs, such as a USB flash drive, a mobile hard disk, a read-only memory (ROM), a random access memory (RAM), a magnetic disk, or a compact disc.

The foregoing embodiments are only used to illustrate the technical solutions of this application, and are not intended to limit the technical solutions. Although this application has been described in detail with reference to the foregoing embodiments, a person of ordinary skill in the art will understand that he/she can still modify the technical solutions described in each foregoing embodiment, or perform equivalent replacements on some of the technical features therein. Such modifications or replacements do not make the essence of the corresponding technical solution depart from the spirit and scope of the technical solution of each embodiment of this application.

What is claimed is:

1. A translation processing method, performed by a computer device, and comprising:
obtaining an input sequence comprising a plurality of segments and segment identifiers, the plurality of segments comprising a source language segment and a target language segment with a mask label, the segment identifiers configured to segment the source language segment and the target language segment, the target language segment being a first original translation of the source language segment, and the mask label being located at a to-be-suggested position of the target language segment;
performing embedding on the input sequence by using a post-editing model to obtain a word vector and a position vector corresponding to the input sequence, and performing embedding based on the segment identifiers to obtain a segment vector;
performing vector fusion by using the post-editing model based on the word vector, the position vector, and the segment vector corresponding to the input sequence to obtain an input vector of the input sequence;
performing encoding by using the post-editing model based on the input vector to output an encoding result; and
performing decoding by using the post-editing model based on the encoding result to output a translation processing result corresponding to the to-be-suggested position.

2. The method according to claim 1, wherein the post-editing model comprises an input layer, an encoder, and a decoder, and wherein:
the performing embedding on the input sequence by using the post-editing model to obtain the word vector and the position vector corresponding to the input sequence, and the performing embedding based on the segment identifiers to obtain the segment vector comprises: obtaining the word vector, the position vector, and the segment vector corresponding to the input sequence by the input layer;
the performing vector fusion by using the post-editing model based on the word vector, the position vector, and the segment vector corresponding to the input sequence to obtain the input vector of the input sequence comprises: obtaining the input vector of the input sequence by the input layer based on the word vector, the position vector, and the segment vector corresponding to the input sequence;
the performing encoding by using the post-editing model based on the input vector to output the encoding result comprises: performing encoding by the encoder based on the input vector to output the encoding result; and
the performing decoding by using the post-editing model based on the encoding result to output the translation processing result corresponding to the to-be-suggested position comprises:
performing decoding by the decoder based on the encoding result to output the translation processing result corresponding to the to-be-suggested position.

3. The method according to claim 2, wherein the translation processing result comprises a plurality of translation candidates of different text lengths.

4. The method according to claim 2, wherein the input vector comprises a plurality of feature vectors obtained after the vector fusion, and the performing encoding by the encoder based on the input vector to output the encoding result comprises:
performing processing by the encoder based on the input vector by using an attention mechanism to obtain an attention weight of each feature vector; and
encoding the input vector by the encoder based on the attention weight to output the encoding result.

5. The method according to claim 4, wherein the attention mechanism is a cross-language attention mechanism, and the performing processing by the encoder based on the input vector by using the attention mechanism to obtain the attention weight of each feature vector comprises:
performing, with each feature vector in the input vector used as a first feature vector, attention calculation on the first feature vector and each second feature vector based on the segment vector in the input vector, to obtain an attention weight of the first feature vector, wherein the second feature vector and the first feature vector belong to different segments.

6. The method according to claim 4, wherein the attention mechanism is a self-attention mechanism, and the performing processing by the encoder based on the input vector by using the attention mechanism to obtain the attention weight of each feature vector comprises:
performing, with each feature vector in the input vector used as a first feature vector, attention calculation on the first feature vector and each third feature vector based on the segment vector in the input vector, to obtain an attention weight of the first feature vector, wherein the third feature vector and the first feature vector belong to a same segment.

7. The method according to claim 1, further comprising:
aligning the source language segment with the target language segment according to the input vector to obtain word alignment information between the source language segment and the target language segment,
wherein the performing decoding by using the post-editing model based on the encoding result to output the translation processing result corresponding to the to-be-suggested position comprises:
performing decoding by using the post-editing model based on the word alignment information and the encoding result, to output the translation processing result.

8. The method according to claim 7, wherein the aligning the source language segment with the target language segment according to the input vector to obtain word alignment information between the source language segment and the target language segment comprises:
predicting a second original translation at the to-be-suggested position by using the post-editing model based on the input vector;
replacing the mask label with the second original translation, to obtain a target language segment after the replacement; and
aligning the source language segment with the target language segment after the replacement to obtain the word alignment information.

9. A method for training a post-editing model, performed by a computer device, and comprising:
obtaining an input sample sequence, the input sample sequence comprising a plurality of sample segments and sample segment identifiers, the plurality of sample segments comprising a source language sample segment and a target language sample segment with a mask label, the sample segment identifiers configured to segment the source language sample segment and the target language sample segment, the target language sample segment being a first original sample translation of the source language sample segment, and the mask label being located at a suggested sample position of the target language sample segment;
performing embedding on the input sample sequence by using an initial network model to obtain a word vector and a position vector corresponding to the input sample sequence, and performing embedding based on the sample segment identifiers to obtain a segment vector;
performing vector fusion by using the initial network model based on the word vector, the position vector, and the segment vector corresponding to the input sample sequence to obtain an input sample vector of the input sample sequence;
performing encoding by using the initial network model based on the input sample vector to output a sample encoding result;
performing decoding by using the initial network model based on the sample encoding result to output a predicted translation processing result corresponding to the suggested sample position; and
training the initial network model based on the predicted translation processing result and a standard translation corresponding to the suggested sample position, to obtain the post-editing model.

10. The method according to claim 9, further comprising:
aligning the source language sample segment with the target language sample segment according to the input sample vector to obtain sample word alignment information between the source language sample segment and the target language sample segment, wherein
the performing decoding by using the initial network model based on the sample encoding result to output the predicted translation processing result corresponding to the suggested sample position comprises:
performing decoding by using the initial network model according to the sample word alignment information and the sample encoding result, to output the predicted translation processing result.

11. The method according to claim 10, wherein the aligning the source language sample segment with the target language sample segment according to the input sample vector to obtain the sample word alignment information between the source language sample segment and the target language sample segment comprises:
predicting a second original sample translation at the suggested sample position by using the initial network model based on the input sample vector;
replacing the mask label with the second original sample translation, to obtain a target language sample segment after the replacement; and
aligning the source language sample segment with the target language sample segment after the replacement to obtain the sample word alignment information.

12. The method according to claim 11, wherein the training the initial network model based on the predicted translation processing result and the standard translation corresponding to the suggested sample position, to obtain the post-editing model comprises:
performing first training on the initial network model based on the second original sample translation and a labeled original sample translation at the suggested sample position;
performing second training on the initial network model based on the predicted translation processing result and the standard translation; and
alternately performing the first training and the second training until a training stop condition is met, to obtain the post-editing model.

13. An apparatus comprising:
a memory storing a plurality of instructions; and
a processor configured to execute the plurality of instructions, and upon execution of the plurality of instructions, is configured to:
obtain an input sequence comprising a plurality of segments and segment identifiers, the plurality of segments comprising a source language segment and a target language segment with a mask label, the segment identifiers being configured to segment the source language segment and the target language segment, the target language segment being a first original translation of the source language segment, and the mask label being located at a to-be-suggested position of the target language segment;
perform embedding on the input sequence by using a post-editing model to obtain a word vector and a position vector corresponding to the input sequence, and perform embedding based on the segment identifiers to obtain a segment vector;
perform vector fusion by using the post-editing model based on the word vector, the position vector, and the segment vector corresponding to the input sequence to obtain an input vector of the input sequence;
perform encoding by using the post-editing model based on the input vector to output an encoding result; and
perform decoding by using the post-editing model based on the encoding result to output a translation processing result corresponding to the to-be-suggested position.

14. The apparatus according to claim 13, wherein the post-editing model comprises an input layer, an encoder, and a decoder, and
wherein in order to perform embedding on the input sequence by using the post-editing model to obtain the word vector and the position vector corresponding to the input sequence, and perform embedding based on the segment identifiers to obtain the segment vector, the processor is configured to obtaining the word vector, the position vector, and the segment vector corresponding to the input sequence by the input layer;
wherein in order to perform vector fusion by using the post-editing model based on the word vector, the position vector, and the segment vector corresponding to the input sequence to obtain the input vector of the input sequence, the processor is configured to obtain the input vector of the input sequence by the input layer based on the word vector, the position vector, and the segment vector corresponding to the input sequence;
wherein in order to perform encoding by using the post-editing model based on the input vector to output the encoding result, the processor is configured to perform encoding by the encoder based on the input vector to output the encoding result; and
wherein in order to perform decoding by using the post-editing model based on the encoding result to output the translation processing result corresponding to the to-be-suggested position, the processor is configured to perform decoding by the decoder based on the encoding result to output the translation processing result corresponding to the to-be-suggested position.

15. The apparatus according to claim 14, wherein the translation processing result comprises a plurality of translation candidates of different text lengths.

16. The apparatus according to claim 14, wherein the input vector comprises a plurality of feature vectors obtained after the vector fusion, and wherein in order to perform encoding by the encoder based on the input vector to output the encoding result, the processor is configured to:
perform processing by the encoder based on the input vector by using an attention mechanism to obtain an attention weight of each feature vector; and
encode the input vector by the encoder based on the attention weight to output the encoding result.

17. The apparatus according to claim 16, wherein the attention mechanism is a cross-language attention mechanism, and wherein in order to perform processing by the encoder based on the input vector by using the attention mechanism to obtain the attention weight of each feature vector, the processor is configured to:
perform, with each feature vector in the input vector used as a first feature vector, attention calculation on the first feature vector and each second feature vector based on the segment vector in the input vector, to obtain an attention weight of the first feature vector, wherein the second feature vector and the first feature vector belong to different segments.

18. The apparatus according to claim 16, wherein the attention mechanism is a self-attention mechanism, and wherein in order to perform processing by the encoder based on the input vector by using the attention mechanism to obtain the attention weight of each feature vector, the processor is configured to:
perform, with each feature vector in the input vector used as a first feature vector, attention calculation on the first feature vector and each third feature vector based on the segment vector in the input vector, to obtain an attention weight of the first feature vector, wherein the third feature vector and the first feature vector belong to a same segment.

19. The apparatus according to claim 13, wherein the process, upon execution of the plurality of instructions, is further configured to:
align the source language segment with the target language segment according to the input vector to obtain word alignment information between the source language segment and the target language segment,
wherein in order to perform decoding by using the post-editing model based on the encoding result to output the translation processing result corresponding to the to-be-suggested position, the processor is configured to:
perform decoding by using the post-editing model based on the word alignment information and the encoding result, to output the translation processing result.

20. The apparatus according to claim 19, wherein in order to the align the source language segment with the target language segment according to the input vector to obtain word alignment information between the source language segment and the target language segment, the processor is configured to:
predict a second original translation at the to-be-suggested position by using the post-editing model based on the input vector;
replace the mask label with the second original translation, to obtain a target language segment after the replacement; and
align the source language segment with the target language segment after the replacement to obtain the word alignment information.
